(19) United States
(12) Patent Application Publication
(10) Pub. No.: US 2026/0095987 A1
(43) Pub. Date: Apr. 2, 2026

(54) LIGHTING CIRCUITS FOR CONTROLLING CLUSTERS OF MICRO-LEDS IN PIXELATED LIGHT SOURCES

(71) Applicant: Infineon Technologies AG, Neubiberg (DE)

(72) Inventors: Mattia Montoncelli, Canda (IT); Rosario Chiodo, Selvazzano Dentro (PD) (IT); Adolfo De Cicco, Castel d'Azzano (VR) (IT); Alberto Bevilacqua, Padua (IT); Paolo Lorenzi, Padua (IT)

(21) Appl. No.: 18/900,092

(22) Filed: Sep. 27, 2024

(51) Int. Cl. H05B 45/3725; F21S 41/153; F21Y 105/16; F21Y 115/10; H05B 45/325; H05B 45/46; H05B 47/155

(52) U.S. Cl. CPC H05B 45/3725; F21S 41/153; H05B 45/325; H05B 45/46; H05B 47/155; F21Y 2105/16; F21Y 2115/10

(57) ABSTRACT

A method of controlling a cluster of micro-LEDs within a larger matrix of micro-LEDs may comprise receiving a reference current at a current-to-voltage converter circuit and generating a reference voltage based on the reference current. The method may also comprise receiving the reference current at N×M micro-LED driver circuits and generating regulated currents for each of N×M micro-LEDs, wherein M and N represent positive integers.

### TECHNICAL FIELD

This disclosure relates to circuits for driving and controlling pixelated light sources, such as for a vehicle headlamp comprising a matrix of light emitting diodes (LEDs).

### BACKGROUND

Driver circuits are often used to control a voltage, current, or power at a load. For instance, a light emitting diode (LED) driver may control the power supplied to one or many light emitting diodes. LED drivers may comprise voltage regulators, linear regulators, or DC to DC power converters, such as buck-boost, buck, boost, or another DC to DC power converter. DC to DC power converters may be especially useful for LED drivers to regulate current through LED strings.

Some LED circuits include a large number of individually controllable LEDs arranged in a two-dimensional matrix. The individually controllable “micro” LEDs can be driven so as to provide different lighting (e.g., high beam or low beam lighting) for different driving conditions, or to provide advanced lighting effects.

Advanced vehicle headlamp systems, for example, are one example application of such matrix LED circuits, whereby lighting effects associated with vehicle operation can be used to improve the driving experience and to promote vehicle safety.

### SUMMARY

In general, this disclosure is directed to circuits used for controlling and driving a pixelated light source, such as those used for advanced vehicle headlamp systems, e.g., a matrix of so-called micro-light emitting diodes (micro-LEDs). The circuits of this disclosure may be configured to control clusters of the micro-LEDs. An individual circuit may be configured to receive a reference current and generate a reference voltage based on the reference current. Rather than implement a current-to-voltage conversation for each individual micro-LED, a single current-to-voltage conversation can be used to generate one reference voltage for an entire N×M cluster of LEDs, where N and M are positive integers. Then, a corresponding number of N×M micro-LED driver circuits may be configured to receive the reference voltage and generate regulated currents for each of N×M micro-LEDs. The reference current and reference voltage may define a regulation loop for the entire cluster (e.g., a closed loop), while each individual micro-LED can still be controlled or adjusted another regulation loop (e.g., an open loop) within each of the N×M micro-LED driver circuits.

In one example, this disclosure describes a lighting circuit configured to control an N-by-M cluster of micro-LEDs. The lighting circuit may comprise a current-to-voltage converter circuit configured to receive a reference current and generate a reference voltage based on the reference current, and N×M micro-LED driver circuits configured to receive the reference voltage and generate regulated currents for each of N×M micro-LEDs, wherein M and N represent positive integers.

In another example, this disclosure describes a method that comprises: receiving a reference current at a current-to-voltage converter circuit and generating a reference voltage based on the reference current; and receiving the reference current at N×M micro-LED driver circuits and generating regulated currents for each of N×M micro-LEDs, wherein M and N represent positive integers.

In another example, this disclosure describes a system that comprises a matrix of micro-LEDs), and a plurality of lighting circuits. Each of the lighting circuits may be configured to control an N-by-M cluster of the micro-LEDs, and each of the lighting circuits may comprise: a current-to-voltage converter circuit configured to receive a reference current and generate a reference voltage based on the reference current; and N×M micro-LED driver circuits configured to receive the reference voltage and generate regulated currents for each of N×M micro-LEDs, wherein M and N represent positive integers.

Details of these and other examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating system that includes a lighting circuit and a processor consistent with this disclosure.

FIG. 2 is a conceptual diagram showing a micro-LED driver matrix and a conceptual close-up view of one driver circuit connected to on micro-LED.

FIGS. 3A and 3B are circuit diagrams showing some example LED and driver arrangements.

FIG. 4 is a block diagram showing an example LED driver that may provide output current (Iout) to an individual LED.

FIG. 5 is a circuit diagram showing current references being routed to micro-LED driver circuits.

FIG. 6 is a block diagram showing a matrix LED system whereby a current reference generator that can generate a reference current for routing to micro-LED drivers.

FIGS. 7A-7C are conceptual diagrams showing different ways of routing signals associated with a reference current to different LED drivers.

FIG. 8 is a block diagram showing one way of routing a current reference signal to multiple LED driver circuits that each include a reference voltage generator.

FIG. 9 is a block diagram showing one way of routing a current reference signal to multiple LED driver circuits that share a reference voltage generator.

FIG. 10 is another conceptual diagram showing another way of routing signals associated with a reference current to different LED drivers.

FIG. 11 is a circuit diagram used to demonstrate power savings that may be achieved according to this disclosure.

FIG. 12 is another block diagram showing one way of routing a current reference signal to multiple LED driver circuits that share a reference voltage generator that can be controlled for yet additional power savings.

FIG. 13 is a flow diagram consistent with one or more examples of this disclosure.

### DETAILED DESCRIPTION

This disclosure is directed to circuits useful for advanced vehicle headlamp systems or other systems that implement a so-called pixelated light source. The circuits may be used to control and drive the lighting elements of a pixelated light source, such as a large number (e.g., greater than 2000) of micro-light emitting diodes (micro-LEDs). The techniques and circuits may address routing area challenges associated with high-density driver circuits associated with high-density pixelated light sources.

Micro-LEDs may generally refer to LEDs with lateral dimensions smaller than 100 micrometers, in some case smaller than 50 micrometers. As the size of micro-LEDs and corresponding driver circuits become smaller and smaller, challenges arise for the routing of electrical signals to the circuits. For example, when the distance between micro-LEDs and the distance between driver circuits becomes less than 100 micrometers, the routing of electrical signals to each of the micro-LEDs becomes especially challenging. When the distance between driver circuits becomes less than 50 micrometers, the issue becomes even more challenging, and may require layers of conductors instead of one layer of conductors, which adds cost.

To control micro-LEDs, signals may be routed to the micro-LED driver circuits. Each micro-LED may have a corresponding micro-LED driver circuit attached thereto. Rather than controlling each micro-LED in a completely separate fashion, the circuits of this disclosure may be configured to perform a current-to-voltage step for clusters of the micro-LEDs. An individual circuit may be configured to receive a reference current and generate a reference voltage based on the reference current. However, rather than implementing current-to-voltage conversation for each individual micro-LED, a single current to voltage conversation can be used to generate one reference voltage for an entire N×M cluster of LEDs, where N and M are positive integers. Then, a corresponding number of N×M micro-LED driver circuits may be configured to receive the reference voltage and generate regulated currents for each of N×M micro-LEDs, wherein M and N represent positive integers. The reference current and reference voltage may define a regulation loop for the entire cluster, while each individual micro-LED can still be controlled or adjusted by another regulation loop within each of the N×M micro-LED driver circuits.

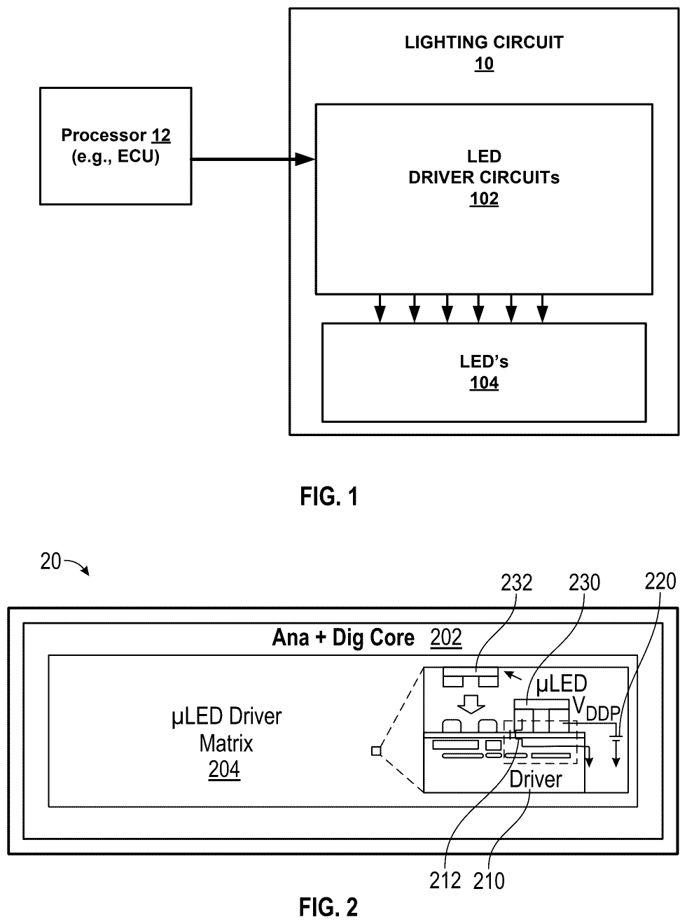

FIG. 1 is a block diagram illustrating system that includes a lighting circuit 10 and a processor 12 consistent with this disclosure. Processor 12 may provide control signals to lighting circuit 10. Based on the control signals, LED driver circuits 102 may provide individual control over LEDs 106. The control signals may comprise pulse modulation (PM) signals, such as pulse width modulation (PWM) signals or other types of modulation signals. LED driver circuits 102 may comprise transistors that are controlled operate as DC/DC converters in order to deliver regulated currents to LEDs 106.

According to this disclosure, lighting circuit 10 may be configured to control individual N-by-M clusters of micro-LEDs in a way that can reduce excessive electrical signals routed to different LED driver circuits 102. In particular, lighting circuit 10 may include a current-to-voltage converter circuit (not shown in FIG. 1) that is configured to receive a reference current and generate a reference voltage based on the reference current. The reference voltage can be shared for each of N×M micro-LED driver circuits, which forms a regulation loop for that cluster. Each of LED driver circuits 102 may be configured to receive the reference voltage and generate regulated currents for each of N×M micro-LEDs, wherein M and N represent positive integers. Thus, a second regulation loop is use for each individual micro-LED in the cluster. Lighting circuit 10 may comprise a vehicle headlamp in some examples, although lighting circuit 10 could also be used in a variety of other settings. For the vehicle example, processor 12 may comprise an electronic control unit (ECU) used for controlling electronics in a vehicle.

High density pixel matrix drivers with dense micro-LEDs pitch (e.g., less than 100 micrometers and especially less than 10 micrometer) face challenges in terms of circuit layout. One particular challenge is the routing of auxiliary signals related to analog driving functions (e.g., routing a reference current signal that is converted to a reference voltage and then routed to each driver circuit).

FIG. 2 is a conceptual diagram showing a micro-LED driver matrix 204 within an analog+digital core 202. FIG. 2 also includes a conceptual close-up view of one driver circuit 210 connected to on micro-LED 230. Micro-LEDs may be individually attached to micro-LED drivers, e.g., as depicted with micro-LED 232 and the arrow showing attachment of micro-LED 232 to a driver circuit that is directly adjacent driver circuit 210. Driver circuit 210 (as well as the other micro-LED driver circuits) includes controllable transistor 212. PM signals control the ON-OFF state of transistor 212 to deliver a controllable amount of current through micro-LED 230. A power source 220 may provide the power supply for driving current through micro-LED 230 by controlling transistor 212. The circuits of this disclosure may be implemented within an analog+digital core 202, such as that shown in FIG. 2.

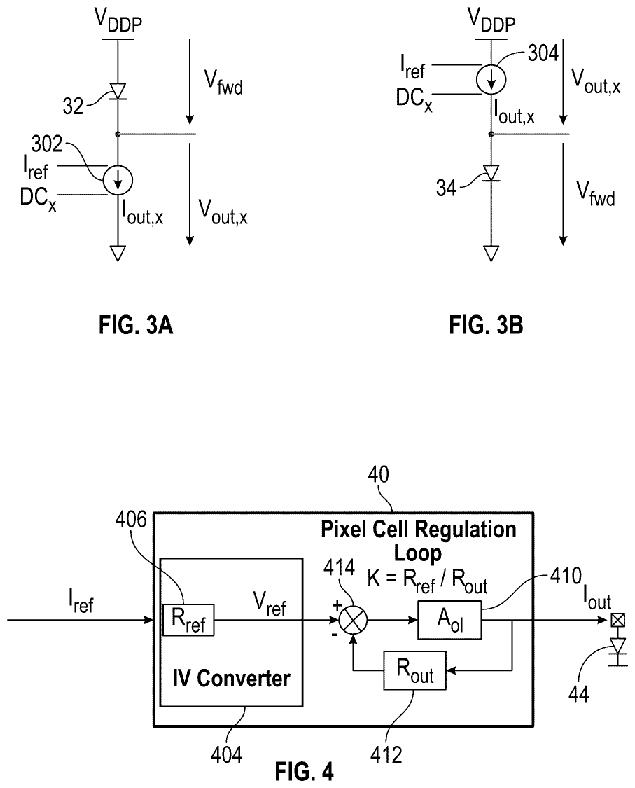

One basic function of a high-density pixel matrix micro-LED driver is to sink or source a regulated current from the cathode/anode of the micro-LED. FIGS. 3A and 3B illustrate two different example layouts. FIG. 3A shows a high-side configuration of micro-LED 32, where a current source 302 is positioned between micro-LED 32 and a ground to delivers current through micro-LED. FIG. 3B shows a low-side configuration of micro-LED 32, where a current source 304 is positioned between a supply node (V_{DDP}) and micro-LED 34.

Every individual micro-LED in a matrix of micro-LEDs may physically need a dedicated analog current signal (Iref) to generate a regulated output current (IOUTx), which may be determined by the formula:

$$IOUTx = k * Iref * D C x$$

where k is a constant “kilis” gain factor and IREF is a reference current. The IREF value may be generally equal across all the micro-LED drivers, and the IREF value may be varied or adjusted within a defined range. This feature allows adjustments to the matrix luminous flux acting as an analog dimming. DCx may comprise a dedicated digital control signal for each micro-LED driver. This DCx signal may contain duty-cycle information provided by an embedded digital dimming PWM engine. The DCx signal may be used to modulate individual pixel brightness defined in an intensity value in a video frame, e.g., by switching a transistor 212 between ON and OFF states. FIGS. 3A and 3B are two different example layouts of for a regulation loop for regulating IREF, which may be used to define Vref for a cluster of LEDs as described here.

Again, two different examples of current source/sink regulation loop designs are show in FIGS. 3A and 3B. FIG. 4 shows one example of a lighting circuit 40 for an individual micro-LED 44 consistent with FIG. 3A or 3B. Lighting circuit 40 may comprise a current-to-voltage converter 404 that includes a reference resistor 406. In addition, lighting circuit 40 may comprise a pixel regulation loop. The pixel regulation loop is shown as open loop gain, where “Aol” 410 represents an open loop gain factor. The output current is fed back through output resistor 412 to node 414 to achieve the open loop gain on the output signal “Iout”.

An input IREF current can be converted in a voltage reference VREF by current-to-voltage converter 404, which is labeled as an IV-converter” sub circuit. Current-to-voltage converter 404 can be implemented using a reference resistor (Rref) 406. Then, the VREF voltage can be regulated over a power stage resistor Rout by an error amplifier with Aol defining an open loop-gain to generate the output current Iout. The resistance Rout represents the feedback element as well. On this current regulation loop, the kilis gain factor may be defined as reference resistor over power stage resistor ratio (i.e., k=Rref/Rout).

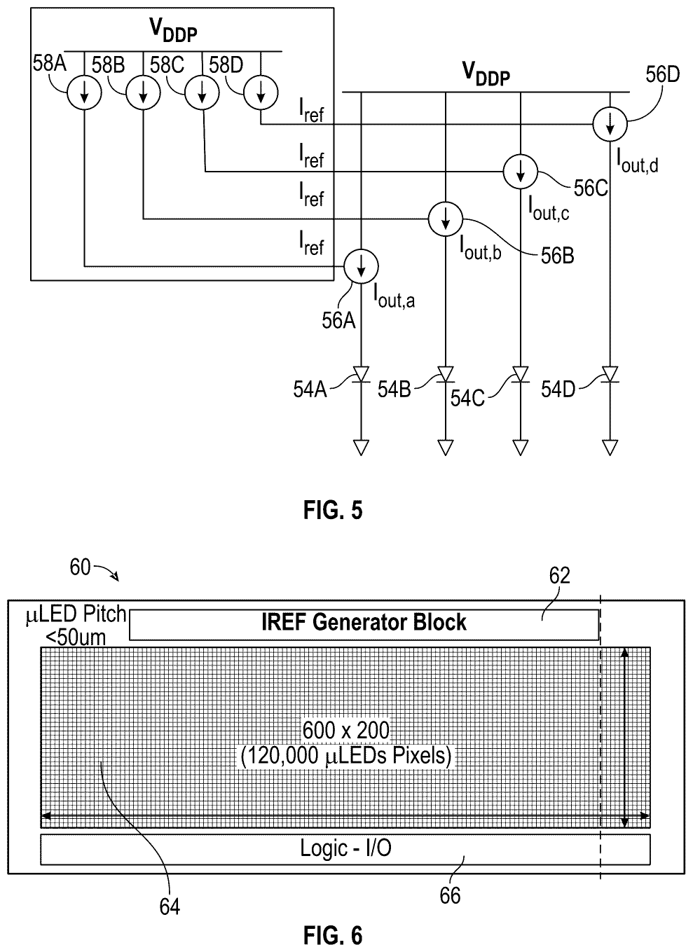

IREF currents utilized by matrix micro-LED drivers may be generated by an accurate current mirror generator supplied by a supply voltage source (e.g., V_{DDP}). FIG. 5 shows an example circuit diagram with current references being routed to micro-LED driver circuits. From floorplan point of view, IREF current mirrors 58A, 58B, 58C, 58D may be placed outside micro-LED matrix. The reference currents from IREF current mirrors 58A, 58B, 58C, 58D are routed to current sources 56A, 56B, 56C, 56D which regulate individual currents to micro-LEDs 54A, 54B, 54C, 54D. The circuits and techniques of this disclosure for generating Vref for clusters of micro-LED drivers may be used within a system like that shown in FIG. 5 in order to improve routing of electrical signals, and possibly to reduce power consumption.

FIG. 6 is a block diagram showing a matrix LED system 60 whereby a current reference generator 62 that can generate a reference current for routing to micro-LED drivers 64. Logic 66 may be included to facilitate control. Routing of the IREF signals becomes challenging in a high-definition matrix with a high number of pixels. The circuits and techniques of this disclosure may be used within a system like that shown in FIG. 6 in order to improve routing of electrical signals, and possibly to reduce power consumption

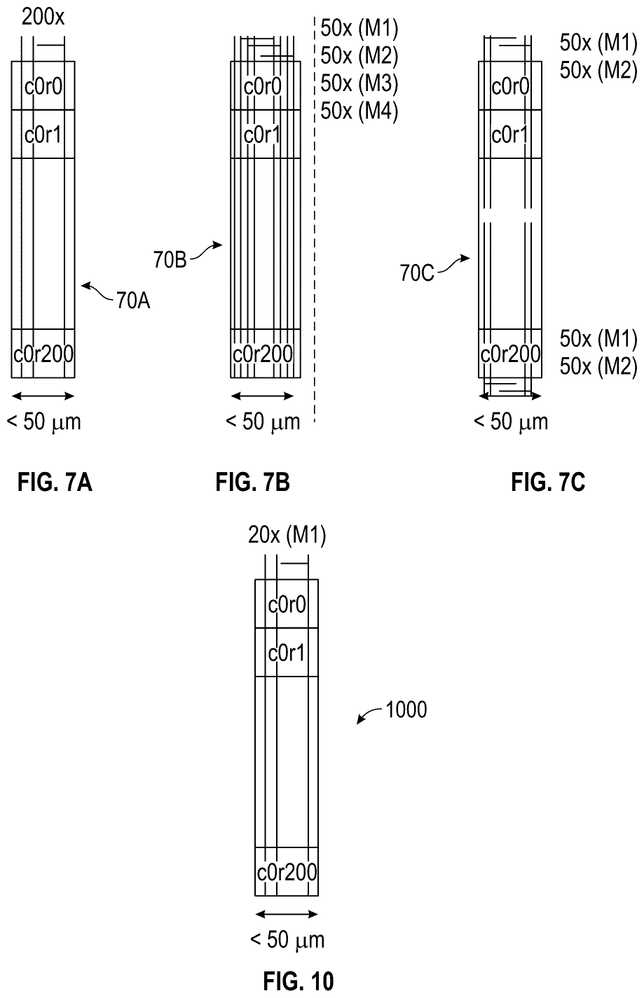

FIGS. 7A-7C are conceptual diagrams showing different ways of routing signals associated with a reference current to different LED drivers. FIG. 7A shows an example 70A where 200 IREF vertical signals need to be routed to each micro-LED driver in a column that pitch of less than 50 micrometers between conductors. FIG. 7A demonstrates a single metal layer (M1) for signal routing. With this high number of signals, however, more dedicated metal layers may be needed, as shown by example 70B of FIG. 7B, to achieve adequate signal routing. The example of FIG. 7B, for example, includes four metal layers (M1, M2, M3 and M4). Extra metal layers, however, add undesirable costs to the circuit. Since a minimum metal pitch is needed to route such dense connections, a further drawback is the reliability of the long thin metal bus where defect density could have a higher impact on product yield. Another technique, that in principle could reduce the number of layers, is to split a current mirror in two parts physically located in different areas of the chip (ex. a part on the top side and a part in the bottom side). Splitting signals is conceptually shown in the example 70C of FIG. 7C. The example of FIG. 7C includes two metal layers (M1 and M2). This approach could be difficult, however, due to other circuit constraints, such as pixel matrix position, logic area or other circuit limitations.

In some aspects, FIG. 7A illustrates the routing congestion problem, FIG. 7B shows an undesirable solution that requires four metal layers to achieve routing, and FIG. 7C shows a signal splitting example that may be useful but still may require multiple layers of conductors.

One aspect of this disclosure is the idea of sharing the current-to-voltage converter (also called “IV converter”) sub-circuit within an M×N micro LED cluster with the aim of reducing or eliminating the problems associated with long analog vertical signal routing. The describe techniques and solutions may also help to reduce the overall system power dissipation.

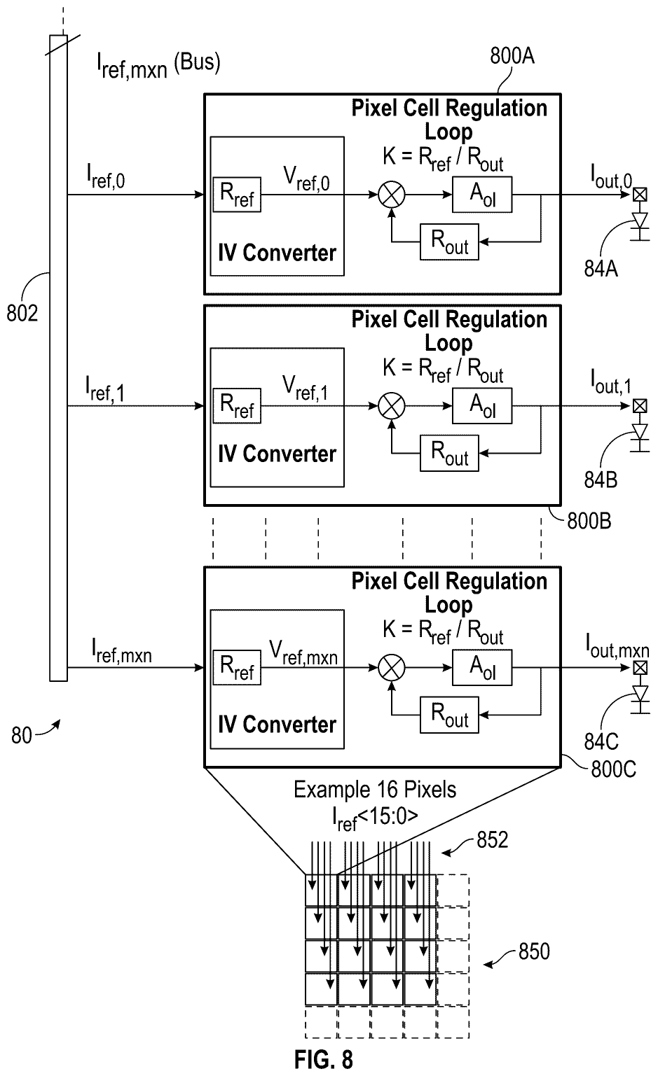

FIG. 8 shows a less desirable example of a system 80 where a bus 802 is configured to send IREF signals to separate sub-circuits 800A, 800B, 800C, which each include separate IV converters. Each separate sub-circuit 800A, 800B, 800C outputs Iout signals to drivers for controlling LEDS 84A, 84B, 84C. Thus, every micro-LED regulation loop receives a dedicated IREF signal as input from the reference current generator block and every micro-LED regulation loop includes a separate IV converter to generate a local VREF needed to regulate the corresponding output current for each of micro LEDs 84A, 84B, 84C. This can cause a severs signal routing problem shown at 852 for routing signals to micro-LED drivers 850.

In contrast to the example shown in FIG. 8, in some examples of this disclosure, the “IV converter” can be shared within a cluster of M×N pixel cell regulation loops, where the “IV converter” still generates a local VREF but it can be utilized by all of the M×N pixel cell regulation loops to generate the M×N LED output currents.

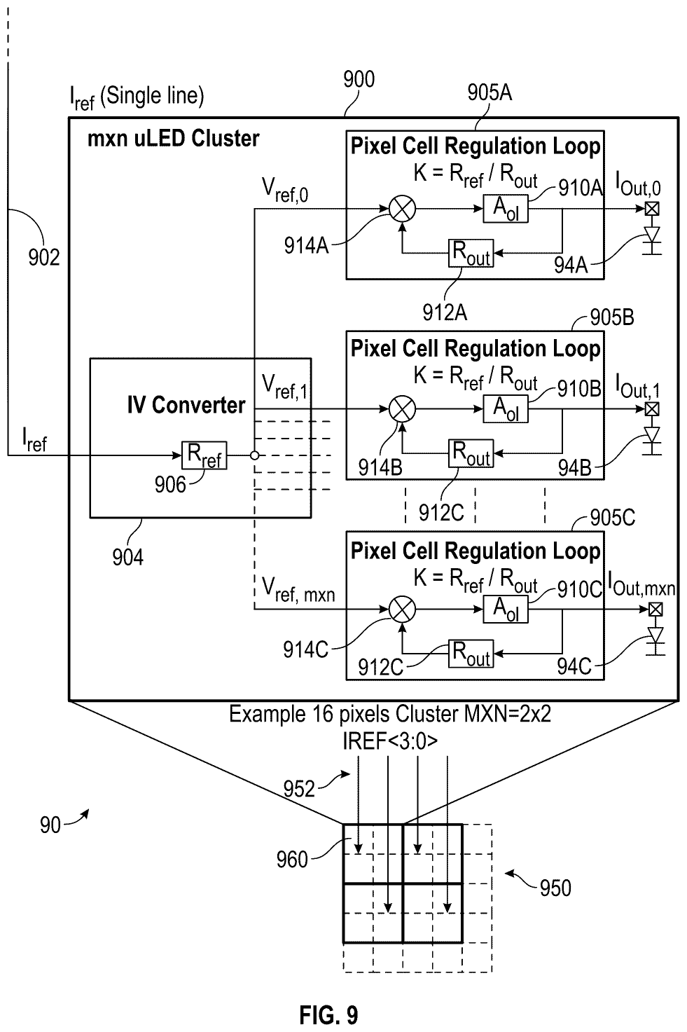

FIG. 9 illustrates a lighting circuit in combination with micro LEDs 94A, 94B, 94C. In FIG. 9, a lighting circuit within system 900 is configured to receive a reference current (I_{REF}) on a single line 902. IV converter 904 includes a resistor 906 or another resistive element to create a reference voltage based on the reference current. The reference voltage is then shared with a plurality of driver circuits 910A, 910B, 910C. Each of driver circuits 910A, 910B, 910C is configured to receive the reference voltage and generate regulated currents for each of N×M micro-LEDs, wherein M and N represent positive integers. Each of driver circuits 910A, 910B, 910C comprise a separate pixel regulation loop. The pixel regulation loops are shown as open loop gain, where “Aol” 910A, 910B, 910C represents an open loop gain factor. The output current is fed back through output resistor 912A, 912B, 912C to node 914A, 914B, 914C to achieve the open loop gain on the output signal “Iout”. The gains for each regulation loop can be defined by output resistors 912A, 912B, 912C that defines a gain as a function of the output resistor and the reference voltage. Thus, in the case where resistors 912A, 912B, 912C have different resistances, the gains would be different for each LED 94A, 94B, 94C. Separate from the pixel regulation loops, however, is a IREF regulation loop as explained above, which may regulate IREF and VREF for the entire cluster of LEDs 94A, 94B, 94C within system 900.

Sharing the IV converter 904 within an M×N micro LED cluster can reduce the number of conductors 952 needed to communicate electoral signals to the driver circuits of a cluster 960. Only one IREF line 902 is needed for each cluster rather than needing a separate IREF line for each individual micro-LED. The closed loop regulation can achieve digital dimming across an entire cluster, while separate pixel regulation loops can achieve different (or similar) lighting by each individual LED in the cluster. Each of the N×M micro-LED driver circuits are directly connected to a particular micro-LED within an N-by-M cluster of micro-LEDs. In other words, a driver circuit is used for each micro-LED, and each individual micro-LED may be attached to a corresponding driver circuit, as conceptually shown in FIG. 2.

Each of the N×M micro-LED driver circuits 910A, 910B, 910C is configured to generate a regulated output current based on the reference voltage. Some or all of the regulated output currents associated with each of the N×M micro-LED driver circuits 910A, 910B, 910C may be different, e.g., by utilizing similar or different output resistors 912A, 912B, 912C to achieve similar or different outputs. Each of the N×M micro-LED driver circuits 910A, 910B, 910C includes an output resistor 912A, 912B, 912C that defines a gain as a function of the particular output resistor 912A, 912B, 912C and the reference voltage generated by IV converter 904 for that cluster of micro-LED driver circuits 910A, 910B, 910C.

The lighting circuit within system 900 may comprise a vehicle headlamp lighting circuit, in which case the N-by-M cluster micro-LEDs represented by micro-LEDs 94A, 94B, 94C may comprise a portion of a matrix of micro-LEDs that form a larger vehicle headlamp. N×M may be less than 50. Clustering size can be selected with the target to have a “local” VREF generation, in order to keep VREF routing short and without any congestion within the cluster. Some example cluster sizes may be 1×4, 1×10, 2×2, 4×2, 8×2, 1×16, 2×16). Any cluster size could work, although cluster sizes with N×M less than 50 is typically desirable. Again, each of the N×M micro-LED driver circuits can define a pixel cell regulator loop for one of the micro-LEDs, while a cluster regulation loop is also defined to regulate IREF and VREF for the cluster.

FIG. 10 is another conceptual diagram showing another way of routing signals associated with a reference current to different LED drivers. FIG. 10 shows an example with 1×10 clustering. In this case, the number of lines needed for 10 separate driver circuits is reduced to allow for the lines to be adequately formed in a single metal layer, even at driver sizes with dimensions of approximately 50 micrometers. In the example of FIG. 10, only one metal layer (M1) is needed for signal routing with a 1×10 cluster and driver size surface area dimensions on the order of 50 micrometers.

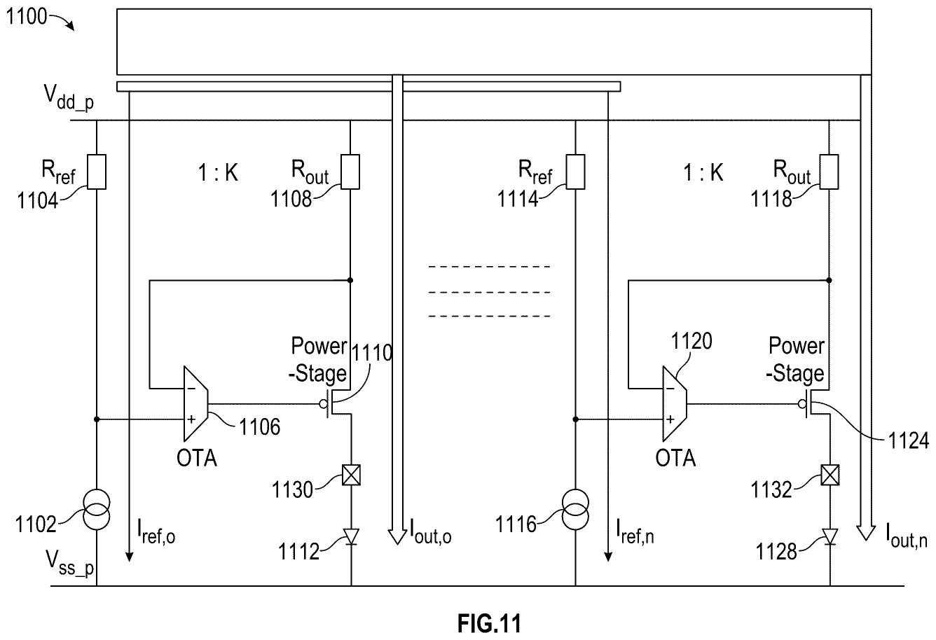

FIG. 11 is a circuit diagram used to demonstrate power savings that may be achieved according to this disclosure. The example shown in FIG. 11 is consistent with a situation where separate IREF currents are provided directly to LED driver circuit, although similar driver circuits to those shown in FIG. 11 may also be used in the scenario where IREF is shared and VREF is generated for a cluster of LED drivers. In FIG. 11, a first driver circuit includes operational transconductance amplifier 1106, output resistor 1108 and power stage 1110 that comprises a transistor controlled by PM signals. An output pin 1130 of the first driver circuit is connected to first LED 1112. Similarly, a second driver circuit includes operational transconductance amplifier 1120, output resistor 1118 and power stage 1124 that comprises another transistor controlled by PM signals. An output pin 1132 of the second driver circuit is connected to second LED 1128. The example shown in FIG. 11 also shows two separate current sources 1102, 1116 and two separate reference resistors 1104, 1114. Reference resistors 1104, 1114 may comprise current to voltage converters that convert the reference current to a reference voltage. Notably, however, there are two separate Iref currents (and generally N×M Iref currents for a cluster). The circuits and techniques of this disclosure may eliminate the extra Iref currents and only use a single Iref current for an entire N×M cluster of LEDs. This can save power by eliminating all but one Iref current for an N×M cluster.

Consistent with FIG. 11, the system overall power dissipation may be given by:

$${P}_{T O T} = {P}_{L E D} + {P}_{IREF} = {\sum }_{x = 0}^{n} V D DP * IREFx * ( 1 + k * D Ctyp )$$

where, P_{TOT} is the total power dissipated, P_{LED} is power through one micro-LED and P_{IREF} is the power consumed by providing an IREF current. The overall power dissipation just related to the reference current generation is given by the formula:

$${P}_{IREF} = {\sum }_{x = 0}^{n} V D DP * IREFx$$

As example, in a 100 k pixel matrix scenario with IOUT being approximately 1 mA and k=50:

$${P}_{T O T} = {\sum }_{x = 0}^{100 k} 4 V * 20 u A * ( 1 + 50 * 0.16 ) = 72 W$$

$${P}_{IREF} = {\sum }_{x = 0}^{100 k} 4 V * 20 u A = 8 W$$

Thus, in some examples, around 11% of the power budget is wasted just for reference current generation. The techniques and circuits descried herein can be employed in order to reduce the power dissipation caused by reference current generation in HD pixel matrix drivers with fine micro-LEDs pitch. For example, in a scenario where an IV converter circuit is added inside every 1×10 cluster, the power dissipation related to reference current generator could be reduced by a factor of 10:

$${P}_{IREF} = {\sum }_{x = 0}^{100 k} 4 V * 20 u A * 1 / 10 = 0.8 W$$

Yet another way to further reduce the power dissipation is to add a logic enable/disable feature to the IV converter circuit driven by the PWM on signal of the respective cluster drivers with adapted PWM driving scheme. In this case, the IV converter circuit may comprise a switch that enables and disables the IV converter such that the IV converter is only active when PWM signals are active (in ON state) for at least one of the LEDs of a cluster. In this case, enhanced PWM algorithms can be used to assign same Phase-Shift to the IV converter that is applied to the pixels of the cluster that share the IV converter. This case save even more IREF power, until P_{IREF} becomes negligible.

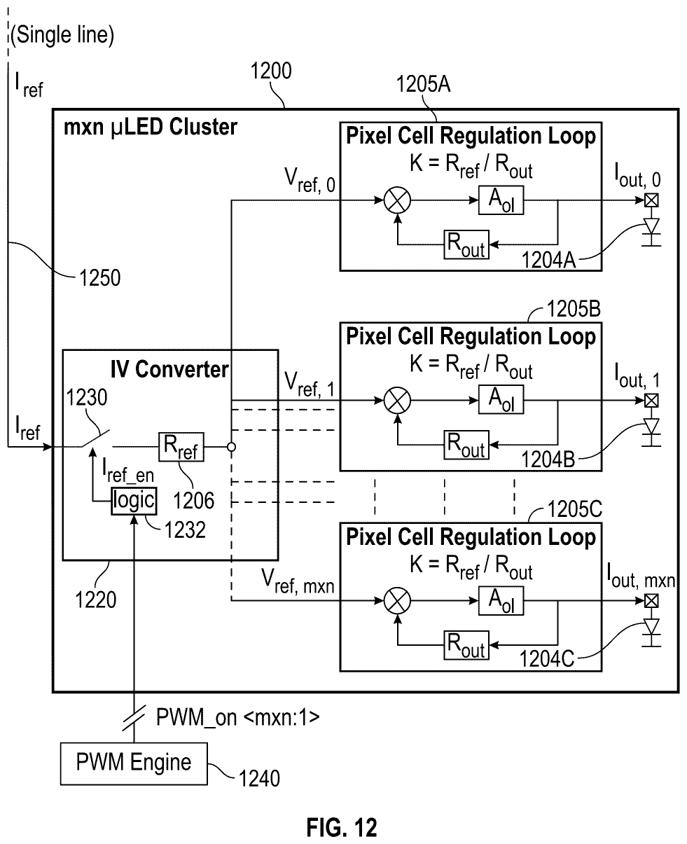

FIG. 12 is a block diagram showing one way of routing a current reference signal to multiple LED driver circuits that share a reference voltage generator that can be controlled for yet additional power savings. The system shown in FIG. 12 is similar to the system shown in FIG. 9, in many respects. Micro-LEDs 1204A, 1204B, and 1204C are similar to micro-LEDs 904A, 904B, and 904C, and driver circuits 1205A, 1205B, and 1205C are similar to driver circuits 905A, 905B, and 905C. A single input line 1250 is used to provide a reference current to IV converter 1220. IV converter 1220 includes a reference resistor 1206 for converting the received reference current on line 1250 to a reference voltage.

Unlike the example in FIG. 9, in FIG. 11 IV converter 1220 a switch 1230 that is configured to enable or disable IV converter 1220 based on whether some or all of the N-by-M cluster micro-LEDs are active. Whether or not some or all of the N×M micro-LEDs are active may be defined by the PWM signals used for controlling ON-OFF states of micro-LEDs 1204A, 1204B, 1204C. Thus, by implementing logic 1232 that receives the same PWM signals used for controlling the ON-OFF states of micro-LEDs 1204A, 1204B, 1204C (e.g., from PWM engine 1240), logic 1232 can be configured to control switch 1230 based on the PWM signals so as to control whether IV converter 1220 is enabled based on whether some or all of the N×M micro-LEDs are active. In other words, switch 1230 can be controlled by logic 1232 to enable or disable the current-to-voltage converter circuit 1220 based on PM signals for the N×M micro-LEDs (represented in FIG. 12 by LEDs 1204A, 1204B, 1204C).

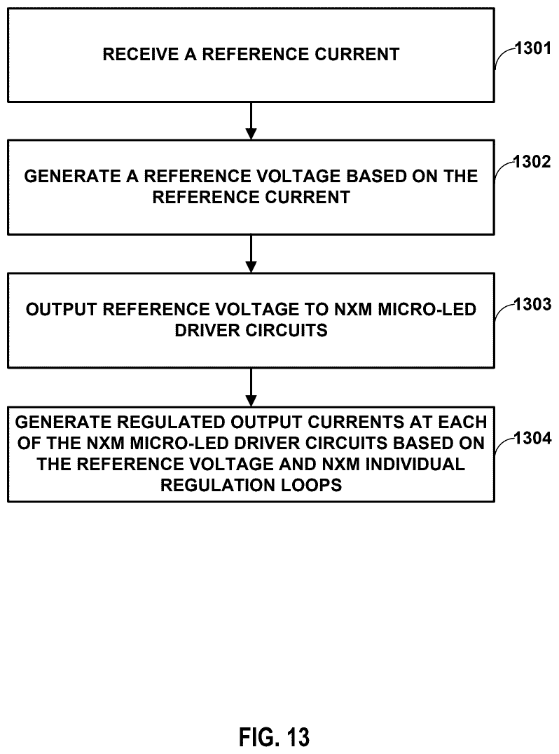

FIG. 13 is a flow diagram consistent with one or more examples of this disclosure. The steps shown in FIG. 13 and described below may be performed by a lighting circuit, e.g., an IV converter and N×M micro-driver circuits such as those described above. A method consistent with FIG. 13 may comprise receiving a reference current (1301) at a current-to-voltage converter circuit and generating a reference voltage based on the reference current (1302). The reference current is output from the current-to-voltage converter circuit to N×M micro-LED driver circuits (1303). Each of the N×M micro-LED driver circuits receive the reference current and generate regulated output currents for each of N×M micro-LEDs based on the reference voltage and N×M individual regulation loops. Again M and N represent positive integers, and N×M may be less than 50.

Again, in various examples, the N×M micro-LEDs may comprises a portion of a matrix of micro-LEDs that form a larger vehicle headlamp. Each of the N×M micro-LED driver circuits defines a pixel cell regulator loop for one of the micro-LEDs, and the method shown in FIG. 12 may further comprise regulating an output current for each of the N×M micro-LEDs. In some cases, s all of the regulated output currents associated with each of the N×M micro-LED driver circuits are different. In some cases, if similar output resistors are used, then the regulated output currents associated with some or all of the N×M micro-LED driver circuits may be similar.

Each of the N×M micro-LED driver circuits includes an output resistor (e.g., resistors 912A, 912B, 912C of FIG. 9) that defines a gain as a function of the output resistor and the reference voltage. In some cases, the current-to-voltage converter circuit includes a switch (e.g., switch 1230 shown in FIG. 12), in which case the method shown in FIG. 12 may further comprise controlling the switch to enable or disable the current-to-voltage converter circuit based on whether some or all of the N×M micro-LEDs are active. As explained herein, controlling the switch 1230 within IV converter 1220 may be based on PM signals for the N×M micro-LEDs.

This disclosure also contemplates systems that include the circuits of this disclosure in combination with the micro-LEDs. Each of the N×M micro-LED driver circuits associated with a cluster of micro-LEDs may be directly connected to a particular micro-LED within an N-by-M cluster of micro-LEDs. A system may comprise a matrix of micro-LEDs, and a plurality of lighting circuits, where each of the lighting circuits is configured to control an N-by-M cluster of the micro-LEDs. The entire matrix may comprise more than 2000 micro-LEDs, divided into N-by-M clusters. The matrix, for example may comprise approximately 4000 micro-LEDs, approximately 8000 micro-LEDs, approximately 16,000 micro-LEDs, approximately 100,000 micro-LEDs, or even more. In any case, consistent with this disclosure, lighting circuits may be configured to control N-by-M clusters of the micro-LEDs using a shared current-to-voltage (“IV”) converter circuit.

Each of the lighting circuits may comprise a current-to-voltage converter circuit configured to receive a reference current and generate a reference voltage based on the reference current, and N×M micro-LED driver circuits configured to receive the reference voltage and generate regulated currents for each of N×M micro-LEDs, wherein M and N represent positive integers. Each of the lighting circuits may include one separate line for receiving the reference current from a reference current generator. The system comprises a vehicle headlamp module, although other lighting scarious are also used for matrix lighting that includes a matrix of micro-LEDs.

The techniques described in this disclosure may be implemented in circuitry. In various examples, the techniques may be implemented, at least in part, in circuitry, hardware, software, firmware or any combination thereof. For example, various aspects of the described techniques may be implemented within one or more logical elements, processors, including one or more microcontrollers, microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such circuitry, hardware, software, and firmware may be implemented within the same device or integrated circuit or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

It may also be possible for one or more aspects of this disclosure to be performed in software, e.g., especially for logic or decisions that are preformed based on circuit output, in which case those aspects of the techniques described in this disclosure may also be embodied or encoded in a computer-readable medium, such as a computer-readable storage medium, containing instructions. Instructions embedded or encoded in a computer-readable storage medium may cause a processor, to perform the method, e.g., when the instructions are executed. The instructions, in this example, may be stored in a memory, which may comprise random access memory (RAM), read only memory (ROM), programmable read only memory (PROM), erasable programmable read only memory (EPROM), electronically erasable programmable read only memory (EEPROM), flash memory, or other computer readable media.

The following clauses may demonstrate one or more aspects of the disclosure.

Clause 1: A lighting circuit configured to control an N-by-M cluster of micro-LEDs, the lighting circuit comprising: a current-to-voltage converter circuit configured to receive a reference current and generate a reference voltage based on the reference current; and N×M micro-LED driver circuits configured to receive the reference voltage and generate regulated currents for each of N×M micro-LEDs, wherein M and N represent positive integers.

Clause 2: The lighting circuit of clause 1, wherein the lighting circuit comprises a vehicle headlamp lighting circuit and the N×M micro-LEDs comprises a portion of a matrix of micro-LEDs that form a larger vehicle headlamp.

Clause 3: The lighting circuit of clause 1 or 2, wherein N×M is less than 50.

Clause 4: The lighting circuit of any of clauses 1-3, wherein each of the N×M micro-LED driver circuits defines a pixel cell regulator loop for one of the micro-LEDs.

Clause 5: The lighting circuit of any of clauses 1-4, wherein each of the N×M micro-LED driver circuits is configured to generate a regulated output current based on the reference voltage.

Clause 6: The lighting circuit of clause 5, wherein some or all of the regulated output currents associated with each of the N×M micro-LED driver circuits are different.

Clause 7: The lighting circuit of any of clauses 1-6, wherein each of the N×M micro-LED driver circuits includes an output resistor that defines a gain as a function of the output resistor and the reference voltage.

Clause 8: The lighting circuit of any of clauses 1-7, wherein the current-to-voltage converter circuit includes a switch configured to enable or disable the current-to-voltage converter circuit based on whether some or all of the N×M micro-LEDs are active.

Clause 9: The lighting circuit of clause 8, wherein the switch is controlled to enable or disable the current-to-voltage converter circuit based on PM signals for the N×M micro-LEDs.

Clause 10: The lighting circuit of any of clauses 1-9, wherein each of the N×M micro-LED driver circuits are directly connected to a particular micro-LED of the N×M micro-LEDs.

Clause 11: A method comprising: receiving a reference current at a current-to-voltage converter circuit and generating a reference voltage based on the reference current; and receiving the reference current at N×M micro-LED driver circuits and generating regulated currents for each of N×M micro-LEDs, wherein M and N represent positive integers.

Clause 12: The method of clause 11, wherein the N×M micro-LEDs comprises a portion of a matrix of micro-LEDs that form a larger vehicle headlamp.

Clause 13: The method of clause 11 or 12, wherein N×M is less than 50.

Clause 14: The method of any of clauses 11-13, wherein each of the N×M micro-LED driver circuits defines a pixel cell regulator loop for one of the micro-LEDs, the method further comprising regulating an output current for each of the N×M micro-LEDs.

Clause 15: The method of clause 14, wherein some or all of the regulated output currents associated with each of the N×M micro-LED driver circuits are different.

Clause 16: The method of any of clauses 11-15, wherein each of the N×M micro-LED driver circuits includes an output resistor that defines a gain as a function of the output resistor and the reference voltage.

Clause 17: The method of any of clauses 11-16, wherein the current-to-voltage converter circuit includes a switch, the method further comprising controlling the switch to enable or disable the current-to-voltage converter circuit based on whether some or all of the N×M micro-LEDs are active.

Clause 18: The method of clause 17, wherein controlling the switch is based on PM signals for the N×M micro-LEDs.

Clause 19: The method of any of clauses 11-18, wherein each of the N×M micro-LED driver circuits are directly connected to a particular micro-LED of the N×M of micro-LEDs.

Clause 20: A system comprising: a matrix of micro-LEDs; a plurality of lighting circuits, where each of the lighting circuits is configured to control an N-by-M cluster of the micro-LEDs, wherein each of the lighting circuits comprise: a current-to-voltage converter circuit configured to receive a reference current and generate a reference voltage based on the reference current; and N×M micro-LED driver circuits configured to receive the reference voltage and generate regulated currents for each of N×M micro-LEDs, wherein M and N represent positive integers.

Clause 21: The system of clause 20, wherein each of the lighting circuits includes a separate line for receiving the reference current from a reference current generator.

Clause 22: The system of clause 20 or 21, wherein the system comprises a vehicle headlamp module.

Various aspects have been described in this disclosure. These and other aspects are within the scope of the following claims.

1. A lighting circuit configured to control an N-by-M cluster of micro-light emitting diodes (micro-LEDs), the lighting circuit comprising:
a current-to-voltage converter circuit configured to receive a reference current and generate a reference voltage based on the reference current; and
N×M micro-LED driver circuits configured to receive the reference voltage and generate regulated currents for each of N×M micro-LEDs, wherein M and N represent positive integers.

2. The lighting circuit of claim 1, wherein the lighting circuit comprises a vehicle headlamp lighting circuit and the N×M micro-LEDs comprises a portion of a matrix of micro-LEDs that form a larger vehicle headlamp.

3. The lighting circuit of claim 1, wherein N×M is less than 50.

4. The lighting circuit of claim 1, wherein each of the N×M micro-LED driver circuits defines a pixel cell regulator loop for one of the micro-LEDs.

5. The lighting circuit of claim 1, wherein each of the N×M micro-LED driver circuits is configured to generate a regulated output current based on the reference voltage.

6. The lighting circuit of claim 5, wherein some or all of the regulated output currents associated with each of the N×M micro-LED driver circuits are different.

7. The lighting circuit of claim 1, wherein each of the N×M micro-LED driver circuits includes an output resistor that defines a gain as a function of the output resistor and the reference voltage.

8. The lighting circuit of claim 1, wherein the current-to-voltage converter circuit includes a switch configured to enable or disable the current-to-voltage converter circuit based on whether some or all of the N×M micro-LEDs are active.

9. The lighting circuit of claim 8, wherein the switch is controlled to enable or disable the current-to-voltage converter circuit based on pulse modulation (PM) signals for the N×M micro-LEDs.

10. The lighting circuit of claim 1, wherein each of the N×M micro-LED driver circuits are directly connected to a particular micro-LED of the N×M micro-LEDs.

11. A method comprising:
receiving a reference current at a current-to-voltage converter circuit and generating a reference voltage based on the reference current; and
receiving the reference current at N×M micro-LED driver circuits and generating regulated currents for each of N×M micro-LEDs, wherein M and N represent positive integers.

12. The method of claim 11, wherein the N×M micro-LEDs comprises a portion of a matrix of micro-LEDs that form a larger vehicle headlamp.

13. The method of claim 11, wherein N×M is less than 50.

14. The method of claim 11, wherein each of the N×M micro-LED driver circuits defines a pixel cell regulator loop for one of the micro-LEDs, the method further comprising regulating an output current for each of the N×M micro-LEDs.

15. The method of claim 14, wherein some or all of the regulated output currents associated with each of the N×M micro-LED driver circuits are different.

16. The method of claim 11, wherein each of the N×M micro-LED driver circuits includes an output resistor that defines a gain as a function of the output resistor and the reference voltage.

17. The method of claim 11, wherein the current-to-voltage converter circuit includes a switch, the method further comprising controlling the switch to enable or disable the current-to-voltage converter circuit based on whether some or all of the N×M micro-LEDs are active.

18. The method of claim 17, wherein controlling the switch is based on pulse modulation (PM) signals for the N×M micro-LEDs.

19. The method of claim 11, wherein each of the N×M micro-LED driver circuits are directly connected to a particular micro-LED of the N×M of micro-LEDs.

20. A system comprising:
a matrix of micro-light emitting diodes (micro-LEDs);
a plurality of lighting circuits, where each of the lighting circuits is configured to control an N-by-M cluster of the micro-LEDs, wherein each of the lighting circuits comprise:
a current-to-voltage converter circuit configured to receive a reference current and generate a reference voltage based on the reference current; and
N×M micro-LED driver circuits configured to receive the reference voltage and generate regulated currents for each of N×M micro-LEDs, wherein M and N represent positive integers.

21. The system of claim 20, wherein each of the lighting circuits includes a separate line for receiving the reference current from a reference current generator.

22. The system of claim 20, wherein the system comprises a vehicle headlamp module.
